(19) United States
(12) Patent Application Publication
(10) Pub. No.: US 2007/0203920 A1
(43) Pub. Date: Aug. 30, 2007

(54) Method and computer program product for handling leafy branches in navigation trees

(75) Inventors: Randal L. Bertram, Raleigh, NC (US); Thomas S. Brugler, Fuquay-Varina, NC (US); Richard F. Bryan, Clinton, NC (US); Mark E. Molander, Cary, NC (US); Kerry A. Ortega, Raleigh, NC (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/361,896

(22) Filed: Feb. 24, 2006

(51) Int. Cl. G06F 17/00

(52) U.S. Cl. 707/100

(57) ABSTRACT

A method for handling leafy branches in a navigational tree including: grouping one or more child nodes into a node group; displaying one or more nodes of a hierarchal system including at least one node group; and displaying a scroll indicator corresponding to the node group, wherein the scroll indicator allows a user to scroll through the node group.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The present invention relates to a method and computer program for selecting and displaying graphic objects and more particularly to a computer program having a graphical user interface with in-line tree filtering.

2. Description of Background

In the field of data processing, resources are conventionally arranged in hierarchical form. A hierarchical arrangement is a multi-level arrangement in which a resource at a particular level is considered to contain or “own” one or more resources at the next lower level. The owning resource may, in turn, be owned or contained within a resource at the next higher level.

Perhaps the easiest way to understand a hierarchical system is by analogy to a filing system conventionally used to store paper documents.

Most businesses include at least one filing room containing multiple filing cabinets. Each of those filing cabinets has several drawers. Each of those drawers is capable of holding several accordion folders. Each of those accordion folders is capable of holding a number of individual project folders. The filing room, filing cabinets, drawers, accordion folders and individual project folders form a multi-level hierarchy.

Beginning at the lowest level, the individual project folders are contained in or “owned” by the accordion folder in which they are contained. All of the accordion folders in a drawer are considered to be “owned” by that drawer. All of the drawers in a particular filing cabinet are “owned” by that cabinet, etc.

In a data processing environment, the most ubiquitous example of a hierarchical system is the file system used for program or data files in a computer system. A computer system often contains multiple physical or logical storage drives. Each of those storage drives may be logically divided into a number of folders, sometimes referred to as directories. With one exception, every folder at every level in a hierarchical file system may contain only folders or folders plus one or more program or data files. The one exception is that the lowest level of a file system hierarchy contains, by definition, only program or data files.

Another example of a hierarchical data processing system is a distributed system. The highest level in a distributed system is a primary 2 is network or extranet made up of the number of individual networks. Each of the individual networks may, in turn, contain smaller networks such as local area networks or LANs. Individual “end-user” devices such as workstations or printers may be connected directly to the LAN media. Alternatively, the individual “end user” devices may be connected to servers that are, in turn, connected to the LAN media.

In describing a hierarchical system in a data processing environment, it is conventional to refer to the hierarchy as a tree and to each object on the tree as a node. The highest-level object on the tree is referred to as the root node and the lowest-level objects on the tree are referred to as the leaf nodes. Nodes other than the root node are described as being on a branch of the tree. Adjacent nodes on the tree are identified as parent nodes or child nodes depending upon their direct relationship to one another. A parent node is any node containing other lower-level nodes (child nodes). The same node may be both a child node (to a higher level parent node) and a parent node (to lower level nodes).

For anything other than the simplest of systems, the size of a tree can become quite large, making it difficult to find individual nodes. A user interface designer may choose to limit the presentation of tree information to a relatively small area at one edge of a display screen, which makes it even more difficult for the user to find nodes of interest in the tree. A user may have to scroll a tree both vertically and horizontally in an effort to locate a node of interest, a process which can be both cumbersome and frustrating since it can be difficult for the user to find the node to begin with and then to appreciate the logical relationship between a given node and the remainder of the tree, very little of which may be viewed at any given time.

A number of different tree representations have been proposed in an effort to make it easier for users to effectively deal with complex trees. Most of these representations require that an entire display screen be given over to the tree representation scheme, which may take the form of nested representations, quasi-three-dimensional representations or even hyperbolic representations of tree structure. Any tree representations which requires the use of an entire display screen is obviously of no practical value where a decision has already been made to limit the space available for tree representations to a relatively small window at one edge of a working area on the display screen. Where the space to be made available for a tree display is limited, a system user has had relatively few tools available for use in navigating through the tree structure.

One well-known tool for managing trees is the use of expand/collapse toggle controls that may be visually represented by ± buttons or directional-arrow buttons, which are sometimes referred to as “twisties”. Selecting an expand/contract button adjacent a particular parent node causes the tree to expand to include both the parent node and all direct child nodes. Selecting the same button adjacent a parent node in an already expanded display will cause all of the displayed child nodes to disappear, leaving only the original parent node.

There are at least two problems with expand/contract controls that limit their usefulness in navigating through a tree structure. First, the controls have to be selected one parent node at the time and then act to expand the display of only direct child nodes. Second, the controls operate on an all or nothing basis. When an expand control associated with a particular parent node is selected, every direct child node is shown on the display screen even if the system user is only interested in locating one or a few of the direct child nodes.

Efforts have been made to overcome some of the problems associated with by expand/collapse controls using filters to limit the tree display to only nodes meeting the filter criteria. Known filter mechanisms come with their own sets of problems. Commonly, a filter is invoked using a dialog box that overlays part or all of the working area of the display screen. Also, known filters are applied only to the direct children of a particular parent node. Filters also typically require the extra user steps of bringing up a filter dialog, selecting filter criteria, and enabling the filter. These kinds of issues and problems limit the flexibility and usefulness of known filter mechanisms.

### SUMMARY OF THE INVENTION

Exemplary embodiments include a method for handling leafy branches in a navigational tree including: grouping one or more child nodes into a node group; displaying one or more nodes of a hierarchal system including at least one node group; and displaying a scroll indicator corresponding to the node group, wherein the scroll indicator allows a user to scroll through the node group.

Exemplary embodiments also include a computer program product for handling leafy branches in a navigational tree including: a storage medium readable by a processing circuit and storing instructions for execution by the processing circuit for facilitating a method including: grouping one or more child nodes into a node group; displaying one or more nodes of a hierarchal system including at least one node group; and displaying a scroll indicator corresponding to the node group, wherein the scroll indicator allows a user to scroll through the node group.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution, which allows a user to easily navigate a large hierarchical system, including leaf nodes, in a single window.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of an initial view of a navigation tree;

FIG. 2 illustrates one example of an expanded navigation tree;

FIG. 3 illustrates one example of a scaleable navigation tree in accordance with exemplary embodiments;

FIG. 4 illustrates another example of a scaleable navigation tree in accordance with exemplary embodiments;

FIG. 5 illustrates yet another example of a scaleable navigation tree in accordance with exemplary embodiments;

FIG. 6 illustrates a further example of a scaleable navigation tree in accordance with exemplary embodiments;

FIG. 7 illustrates still another example of a scaleable navigation tree in accordance with exemplary embodiments;

FIG. 8 illustrates a scalable navigation tree including a search function in accordance with exemplary embodiments; and

FIG. 9 illustrates the scalable navigation tree including a search function of FIG. 8.

The detailed description explains the preferred embodiments of the invention, together with advantages and features, by way of example with reference to the drawings.

### DETAILED DESCRIPTION OF THE INVENTION

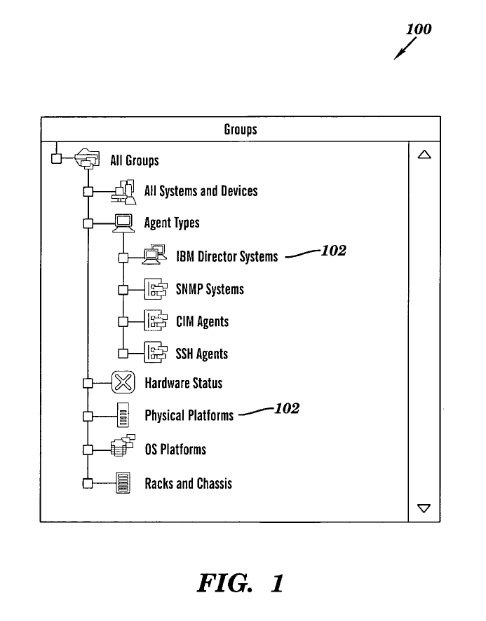

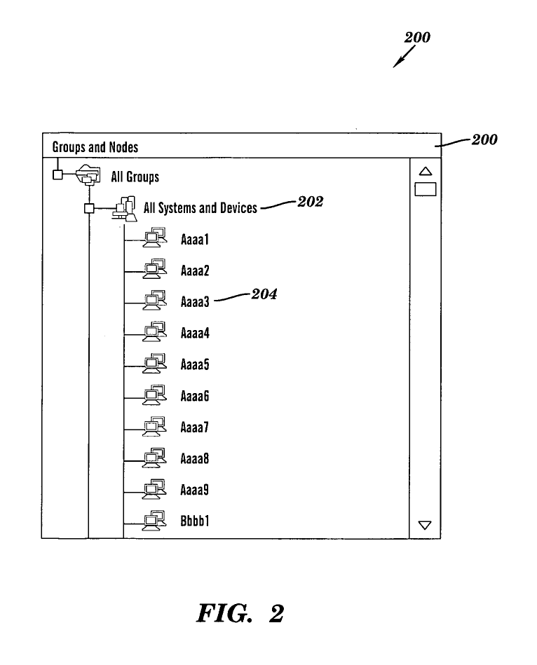

Turning now to the drawings in greater detail, prior art FIG. 1 illustrates a traditional navigation tree 100 for a hierarchical system including several nodes 102. The navigation tree 100 does not depict any leaf nodes. The navigational tree 100 makes it easy for user to understand the key folders/containers and their relationships in the hierarchical system. Prior art FIG. 2 illustrates a traditional navigation tree 200 for a hierarchical system including nodes 202 and several leaf nodes 204. One drawback of showing leaf nodes in a navigation tree is scalability. For example, some folders can contain hundreds or thousands of leaf nodes 204, so traditional navigational trees would be much more difficult for users to effectively use if they expanded from tens of categories/groups/folders to thousands of leaf nodes. As depicted in FIG. 2, only the several leaf nodes 204 and only two non-leaf container nodes 202 are displayed with in the navigation tree display. The limited number of non-leaf container nodes 202 in the display makes it more difficult for a user to understand the key folders/containers and their relationships in the hierarchical system. Additionally, the user may have to scroll through potentially huge lists of leaf nodes 204 to find a particular leaf node 204. Accordingly a scalable navigation tree has been developed to allow a user to easily navigate a large hierarchical system, including leaf nodes, in a single window. As used herein, a leafy branch refers to a parent node with lots of children nodes.

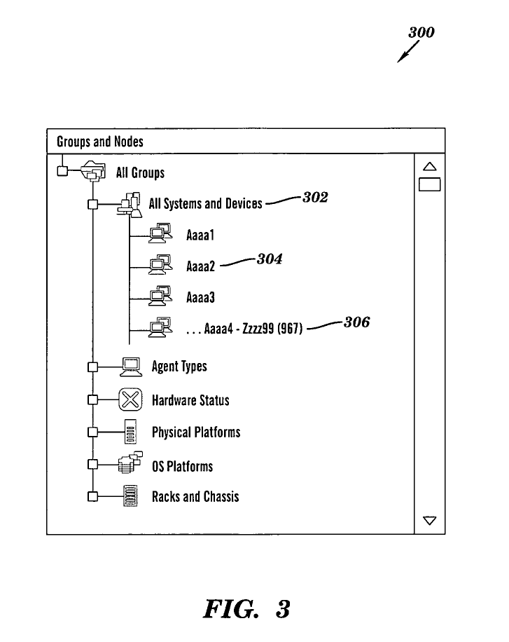

Referring now to FIG. 3, a scaleable navigation tree 300 in accordance with exemplary embodiments is depicted. The scalable navigation tree 300 includes several container nodes 302, several leaf nodes 304, and a node group 306. In exemplary embodiments, the node group 306 is not limited to a group of leaf nodes 304, but may contain several leaf nodes and child nodes. The scalable navigation tree 300 addresses the issue of scalability by localizing and containing potentially out-of-scale branches or leaf nodes 304 within the navigation tree 300 into the node group 306. As depicted in FIG. 3, the scaleable navigation tree 300 may display a small number of leaf nodes 304, and then use the node group 306 to represent the remaining leaf nodes 304. The grouping of several leaf nodes 304 into a node group 306 allows the display window to display several high-level container nodes 302. In exemplary embodiments, the node group 306 may be represented by a cloud or ellipses used to indicate the existence of several peer nodes that are not individually listed, as shown in FIG. 3. For example, the number shown, “967”, indicates how many nodes 304 are in the corresponding node group 306.

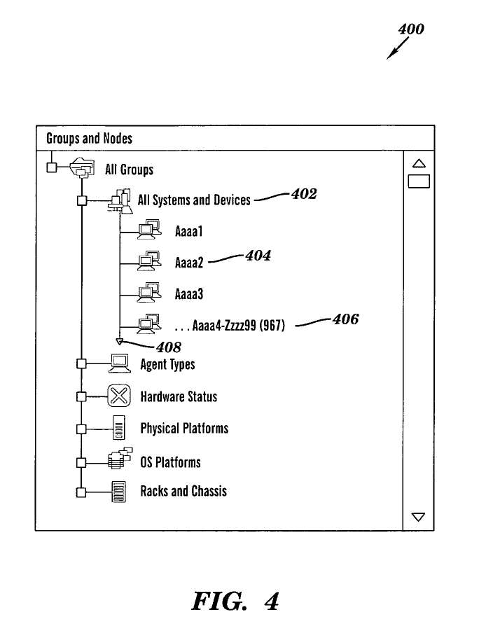

Turning now to FIG. 4, another scaleable navigation tree 400 in accordance with exemplary embodiments is depicted. In exemplary embodiments, it may be beneficial to allow users to quickly scroll through a branch of a navigational tree without scrolling through the whole navigational tree. Accordingly, as shown in FIG. 4, a scroll indicator 408 may be used to allow a user to scroll through a particular branch of the scaleable navigational tree 400. The scroll indicator 408 may be an up and/or down arrow located next to the node group 406. In one embodiment, the scroll indicator 408 may have a high-gain control that is used to navigate the node group 406 quickly.

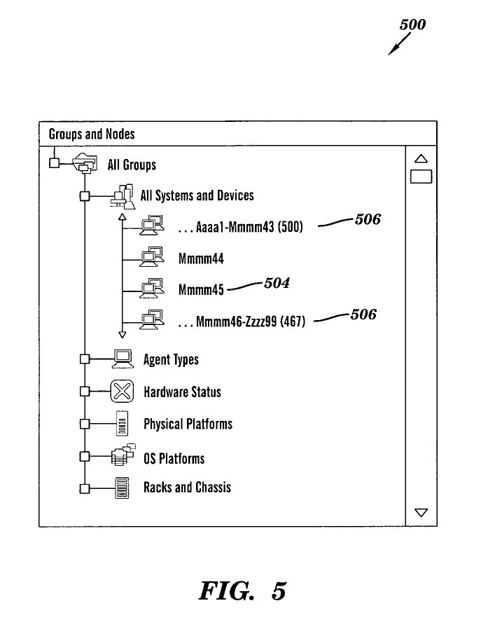

Turning now to FIG. 5, yet another scaleable navigation tree 500 in accordance with exemplary embodiments is depicted. In exemplary embodiments, if a user scrolls down though a node group, two node groups 506 may be displayed allowing the user to scroll up or down through either of the node groups 506. FIG. 5 illustrates how the node groups 506 on both ends of the displayed branch could provide information about the peer nodes that comprise the node group 506. For example, the number of nodes in the node group 506 and alphabetic ranges of the names of the nodes in the node group 506 could be displayed.

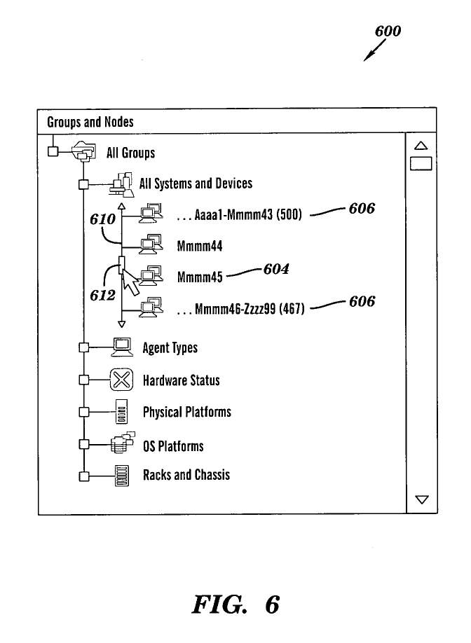

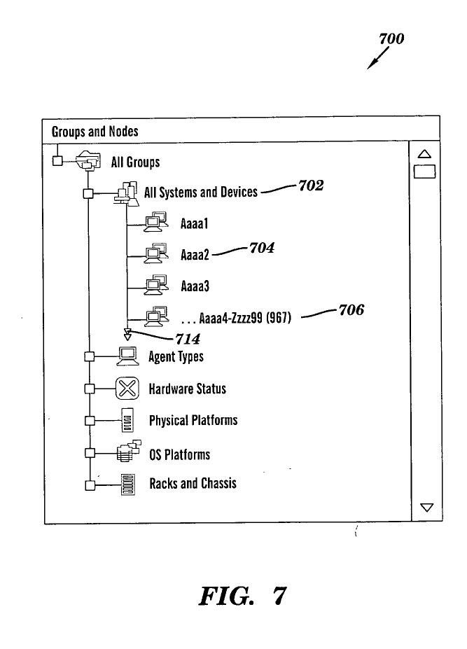

Another enhancement, as shown in FIG. 6, to a scaleable navigation tree 600 is to add an elevator control 610 to the node-level scroll shaft 612. In an exemplary embodiment, the user could directly grab the elevator 610 to quickly navigate within the leafy branch (e.g., the user could use the elevator to adjust which leaf nodes are being displayed). In other exemplary embodiments, if the user wanted to see all the leaf nodes 706 in the leafy sub-branch, he/she could simply click an expand control 714 to fully expand sub-branch. In exemplary embodiments, the expand control 714 may be a “double-down” arrow button as shown in FIG. 7. Additionally, a surface-level inline expand button 714 might also be useful to quickly show/hide all the leaf nodes 704 in a node group 706.

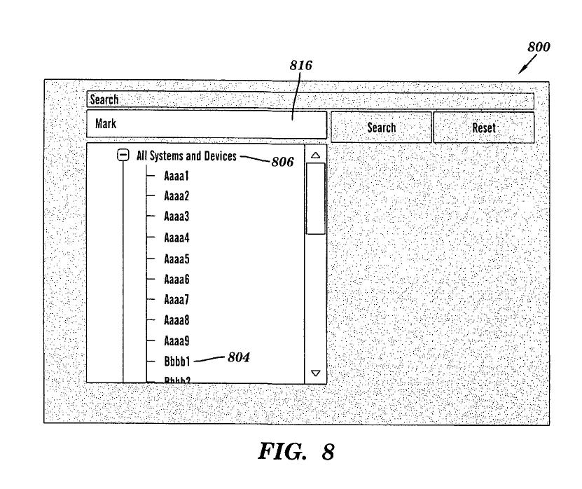

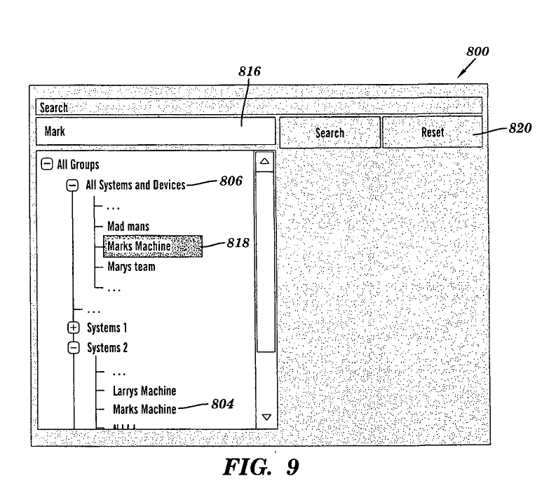

In exemplary embodiments, it may be difficult for a user to find and stop scrolling on a specific node using a scroll indicator or an elevator and therefore it may be difficult for a user to quickly select a desired node. Accordingly, a search field may be used in conjunction with a scalable navigation tree to allow a user to maintain a high-level view of the navigation tree while displaying the desired node. FIGS. 8 and 9 depict a scalable navigation tree including a search field in accordance with exemplary embodiments.

As shown in FIG. 8, a scalable navigation tree 800 may include a search field 816 that allows a user to search a node group 806 for a desired node. In exemplary embodiments, the search field 816 allows a user to enter the name of a desired leaf node and select a node group 806 or a node 802 to search for the desired node 802. Once the user selects the node 802 or node group 806 to be searched and enters the search terms, the desired node 818 may be highlighted, as shown in FIG. 9.

For example, a user may type the name of a desired node in the search field to search for a specific system. After executing the search, each branch of the tree containing the desired node may be opened, and pruned such that the navigational tree only shows the relevant branches and some context. In exemplary embodiments, the objects immediately before and after the item found may be displayed. Furthermore, not only are the objects around the desired node displayed but also the folder(s) containing the desired node. In exemplary embodiments, the scalable navigation tree 800 may include a reset button 820 which, displays the whole navigational tree again but leaves the item selected and in view.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for handling leafy branches in a navigational tree comprising:
grouping one or more child nodes into a node group;
displaying one or more nodes of a hierarchal system including at least one node group; and
displaying a scroll indicator corresponding to the node group, wherein the scroll indicator allows a user to scroll through the node group.

2. The method of claim 1, further comprising displaying a folder-level scroll shaft and a corresponding elevator, wherein the elevator allows the user to scroll through the child nodes and the node group.

3. The method of claim 2, further comprising:
displaying a search field;
receiving a search command from the user;
searching the child nodes responsive to the search command; and
highlighting a desired child node responsive to the search command.

4. The method of claim 3, further comprising:
displaying a expand control corresponding to the node group, wherein the expand control allows the user to expand the node group and display all of the child nodes in the node group.

5. The method of claim 4, wherein:
displaying the at least one node group includes displaying the number of child nodes in the at least one node group.

6. The method of claim 5, wherein
displaying one or more nodes of a hierarchal system including at least one node group includes:
displaying a first node group preceding child nodes in a hierarchy, the first node group displayed along with the number of child nodes in the first node group;
displaying the child nodes; and
displaying a second node group following the child nodes in the hierarchy, the second node group displayed along with the number of child nodes in the second node group.

7. A computer program product for handling leafy branches in a navigational tree comprising:
a storage medium readable by a processing circuit and storing instructions for execution by the processing circuit for facilitating a method comprising:
grouping one or more child nodes into a node group;
displaying one or more nodes of a hierarchal system including at least one node group; and
displaying a scroll indicator corresponding to the node group, wherein the scroll indicator allows a user to scroll through the node group.

8. The computer program product of claim 7, further comprising displaying a folder-level scroll shaft and a corresponding elevator, wherein the elevator allows the user to scroll through the child nodes and the node group.

9. The computer program product of claim 8, further comprising:
displaying a search field;
receiving a search command from the user;
searching the child nodes responsive to the search command; and
highlighting a desired child node responsive to the search command.

10. The computer program product of claim 9, further comprising:
displaying a expand control corresponding to the node group, wherein the expand control allows the user to expand the node group and display all of the child nodes in the node group.

11. The computer program product of claim 10, wherein:
displaying the at least one node group includes displaying the number of child nodes in the at least one node group.

12. The method of claim 11, wherein
displaying one or more nodes of a hierarchal system including at least one node group includes:
displaying a first node group preceding child nodes in a hierarchy, the first node group displayed along with the number of child nodes in the first node group;
displaying the child nodes; and
displaying a second node group following the child nodes in the hierarchy, the second node group displayed along with the number of child nodes in the second node group.
